(19) United States
(12) Patent Application Publication
(10) Pub. No.: US 2005/0062015 A1
(43) Pub. Date: Mar. 24, 2005

(54) COOLANT ADDITIVES CONTAINING STRONTIUM MINERAL POWDER

(76) Inventor: Hiroshi Kobori, Fukuoka (JP)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/751,042

(22) Filed: Jan. 2, 2004

(30) Foreign Application Priority Data
Sep. 22, 2003 (JP) 2003-330517

(51) Int. Cl. C09K 5/00

(52) U.S. Cl. 252/71

(57) ABSTRACT

Radiator coolant additives that include strontium mineral powder and increase fuel efficiency and reduce emissions from internal combustion engines. In addition to the strontium mineral powder, the coolant additives include a surfactant that facilitates the scattering or dispersion of the strontium mineral powder when the radiator coolant additive is added to a radiator coolant. The coolant additives can also include a carrier, such as water and ethylene glycol. When used in a radiator coolant during operation of an automobile engine, the strontium mineral powder causes positive ions to be generated in the coolant. At the same time, negative ions are generated in the fuel within the cylinders of the engine. These ions result in an electromagnetic wave around the pistons of the engine, which enhances fuel combustion.

### RELATED APPLICATIONS

This application claims the benefit under 35 U.S.C. §119 of foreign patent application No. 2003-330517, filed in Japan on Sep. 22, 2003, which is incorporated by reference.

### BACKGROUND OF THE INVENTION

1. The Field of the Invention

The present invention relates to compositions and methods for increasing automobile engine performance. More particularly, the present invention relates to a radiator coolant additive which increases the horsepower and fuel combustibility of an engine.

2. The Relevant Technology

There are several known methods which increase the fuel combustibility of engines and reduce the toxic gases emitted from engines' exhaust. One such method is to apply paint that contains electrical mineral powder, on the duct, hose, or pipe in which an engine's oil and coolant flows. A second known method is to wrap the duct, hose, or pipe with a belt containing electrical mineral powder. A third common method is to add the actual electrical mineral into the engine's coolant and let the fluid run through the engine's cooling system. Following are known facts related to these technologies.

Published Japanese patent application #2003-161152 discloses a radiator coolant which has an electrical mineral in it to ion activate the fuel mixture gas to increase horsepower and improve gas mileage. Often, however, the polarization and ion activation by the coolant using the electrical mineral in this manner is insufficient. Also, the electrical mineral can condense in the coolant, resulting in less collision of molecules, thereby minimizing the electrical effects.

Published Japanese patent application #2002-235611 discloses a substance transforming device that consists of an electrical mineral which is wrapped around the bypass flow of a radiator hose, changing the pressure and temperature to generate radiant energy. For this is to be operational, an additional device that provides the extra layer of the electrical mineral to the engine and its cooling system must be installed. Another drawback to this device is that it requires periodic maintenance and is not economical nor easily used by the public.

### BRIEF SUMMARY OF THE INVENTION

The present invention solves the aforementioned problems by scattering an electrical mineral in the coolant associated with an automobile engine. This not only gives excellent electrical polarization characteristics which increases fuel efficiency, but it is also easy to use and alleviates any costly maintenance.

The present invention relates to compositions and methods for increasing automobile engine horsepower and fuel combustibility. In one embodiment, this additive provides an electrical mineral having polarization effects, such as a strontium mineral powder, and a scattering or dispersion agent that causes the electrical mineral to disperse or freely float in the coolant. The coolant additive is added into an engine's radiator and cooling system. In one embodiment of the invention, these beneficial results are achieved as the coolant additive enhances the ion activation of gasoline and diesel fuel due to an electromagnetic wave and ion effect generated by electrical polarization effects of the strontium mineral powder. The coolant additive dramatically increases the engine's fuel efficiency and horsepower. It also eliminates an extra step of installing an additional device to the engine. Adding the proper volume of the additive to the cooling system provides higher fuel efficiency, increases the ionization of the air in the passenger compartment, and is very economical and easy to use.

In one embodiment, the coolant additive includes minerals such as beta quartz, Anorthite, or other electrical minerals as active ingredients, which are maintained in the mixture at a volume percentage in a range from about 10% to about 30%. By mixing a strontium mineral powder to the coolant and circulating it around the engine, the radiator can obtain activation of fuel and negative ion effects around the surrounding environment with minimum additive to the coolant.

In another embodiment, adding the coolant additive at a volume percentage in a range of about 2.5% to about 3.0% to the coolant keeps the active ingredients freely afloat in the coolant. This ensures that reciprocal action of electromagnetic waves resulting from motion of the strontium mineral powder occurs, thereby increasing fuel efficiency and decreasing emission.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other objects and features of the present invention will become more fully apparent from the following description and appended claims, or may be learned by the practice of the invention as set forth herein.

### BRIEF DESCRIPTION OF THE DRAWINGS

To further clarify the above and other advantages and features of the present invention, a more particular description of the invention briefly described above will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates the cooling system of a typical automobile engine.

FIG. 2 is a chart displaying test results obtained by using the present invention on various automobiles

FIG. 3 is a graph indicating the relationship between speed (km/h) and power (ps) when a coolant additive is added to the coolant of a first automobile.

FIG. 4 is a graph indicating the relationship between speed (km/h) and power (ps) when a coolant additive is added to the coolant of a second automobile.

### DETAILED DESCRIPTION OF THE PREFERRED EMBODIMENTS

The present invention relates to compositions and methods for increasing automobile engine horsepower and fuel combustibility. Embodiments of this invention increase horsepower, increase fuel efficiency, reduce engine noise, remove odor inside the automobile, and protect the coolant. Coolant additives according to embodiments of the invention include strontium mineral powder. When the additive is mixed with the coolant, the strontium mineral powder freely floats in the coolant and is circulated inside the cooling system.

I. Coolant Additives and Constituents Thereof

In certain embodiments, the strontium mineral powder with electronic polarization effects also includes beta quartz (SiO₂) or Anorthite (CaAl₃Si₂O₈). In other embodiments, the electrical mineral powder can include strontium (Sr) or zirconium (Zr) with one or more other elements or chemical constituents including one or more of the following: Silicon (Si), Aluminum (Al), Iron (Fe), Calcium (Ca), Zirconium (Zr), Strontium (Sr), Titanium (Ti), and Potassium (K). The presence of these elements or chemical constituents can be identified, for example, using x-ray diffraction methods or qualitative analysis using fluorescent x-rays.

The strontium mineral powder can be used by itself or can be mixed with ceramic powder at a certain ratio and size (e.g., about 0.1 mm to about 500 μm). The electrical mineral used in one embodiment is a hex-crystal having the chemical constituents (Ca, Na) X₃Al₆ (BO₃) 3Si₆O₁₈ (OH, F) 4 that are Boron and Silicate (where X is Mg, Fe, Mn, Li, Al, etc.). One source for such electrical minerals is granite. Because these electrical minerals display electronic polarizing effects and generate static electricity in their natural state when stress is applied, it creates piezoelectricity. There are different types of coolant additives, but ones that has Strontium as an active ingredient is most effective.

Strontium and zirconium change the crystal structure of the mineral constituents and strengthen the characteristics of electrical polarization. Utilizing this characteristic, it is possible to increase horsepower, decrease emissions, increase fuel efficiency, and eliminate odors from the coolant that circulates through the cooling system. It is suggested in one embodiment that the total content of strontium is in a range of about 0.5% to about 1.0% of the total volume of solid constituents in the coolant additive. When the concentration of strontium is less than about 0.5% by volume, the electrical polarization effects are minimal. In this case, the ion activation caused by the generation of electromagnetic waves of strontium mineral powder within the cooling system cannot provide satisfactory power increase effects. On the other hand, if the concentration of strontium is greater than about 1.0% by volume, there is no significant increase in electronic polarization, without additional processing steps.

A surfactant can be used as a scattering agent which exists in the liquid-solid interface and changes the interface energy, resulting in changes to the interface characteristics. This scattering agent is adsorbed on the surface of the strontium mineral powder and creates an adsorbing layer which has a higher concentration than the solution layer. The scattering agent then reduces the surface tension of the coolant, thereby enabling the strontium mineral powder to be evenly distributed in the coolant.

Surfactants are roughly divided into two major groups depending on their water solubility: ion surfactants and non-ion surfactants. As negative ion surfactants, ABS and Fat Group Alcohol Sulfate Ester Salt can be applied. As positive ion surfactants, various Armeen inducers can be applied. For the non-ion surfactant, Polyethylene Oxide and Sugar Ester can be applied. For embodiments of this invention, the best surfactants are selected based on the types and form of the strontium mineral powder. To cause the mineral powder to be scattered in the coolant in one embodiment, a colloidal form including 49.01% by volume of Silica, 2.95% by volume of Iron Oxide, 0.56% by volume of Calcium Oxide, 18.85% by volume of Water, 16.45% by volume of Aluminum Oxide, 1.15% by volume of Magnesium Oxide, 2.65% by volume of Potassium Oxide, 1.10% by volume of Carbon Dioxide, 1.69% by volume of Sodium Oxide, 0.01% by volume of Phosphoric Acid, 0.02% by volume of Manganese Oxide, and 0.20% by volume of Titanium Oxide can be used as an additive.

II. Methods of Using Coolant Additives

The coolant additive is added to coolant that is circulated through the engine, radiator, and pump (inside the cooling system) of the automobile.. The main ingredients of the additive are the acidic water created by the electrolysis and Ethylene Glycol. Other additives can include Phosphoric Acid, Molybdenum Acid, Silica, Nitric Acid, Nitrite, and Armeen. The mixture may comprise an Organic Acid and Carboxylate as the main body, adding Inorganic Alkaline Salt as an anti-rusting agent. Boric Acid Soda and Alkanol Armeen have been used to keep the coolant on the alkaline. However, when Alkanol Armeen is heated over 90° C., it tends to melt non-ferrous metals such as copper. Also, Boric Acid Soda is known to corrode aluminum and its use in the coolant is sometimes avoided.

A coolant additive to which strontium mineral powder has been added generates electromagnetic wave energy from reciprocal action of the particles, and its effects get stronger as temperature increases. As a result, the coolant in the radiator is ionized and starts generating a positive charge around the cylinder where the temperature is the highest. The coolant starts carrying positive ions. Negative ions are generated inside the cylinders due to the high revolution of the pistons inside the cylinders. When this happens, electrons start to migrate between the positive and negative ions causing an electromagnetic wave or current. Electrons move fastest under high temperatures. Thus, around the cylinders where the temperature is highest, this transmission of electrons creates a strong electromagnetic wave. This electromagnetic wave instantly breaks the molecules of fuel that enters the combustion chamber down, causing the fuel to be more combustible. Also, the air that is in the fuel mixture contains negatively charged ions which repel the negative ions within the cylinder. This promotes the perfect combustion of the fuel and at the same time increases the combustion speed, and as a result, fuel burns at a lower temperature and makes the low-temperature perfect combustion possible. Because the fuel is burning at a lower temperature, NOx from the exhaust is reduced.

It is possible to obtain an increase in power, an increase in fuel efficiency, a decrease in emission, a stabilization of the water temperature, and extend the life of the coolant by generating positive ions by putting the coolant additives disclosed herein in the cooling system. Heat from the coolant goes through the heater core and is released to the passenger compartment. When the heat is released, substantial amount of negative ions are generated. Therefore, while the engine is running, it continues to generate negative ions and to neutralize the positively charged odors which cause smells inside the passenger compartment. As a result, emissions are reduced, fuel efficiency is increased, engine noise is reduced, horsepower is increased, odors are removed, and coolant is protected.

Negative ions in this case include atoms and molecules, which can be generated from processes exhibiting Lenard effects. Positive and negative ions naturally occur in the air, and there are more negative ions than positive ions in the woods and near waterfalls. This is one aspect of what refreshes and relaxes people in these environments. According to embodiments of the present invention, when fuel is combusted, negative ions break the molecules of fuel down to single molecules which allow them to bond with oxygen in a more efficient manner, thus promoting better fuel efficiency. Negative ions also break down adulterants to minimize the obstacles for leaner combustion.

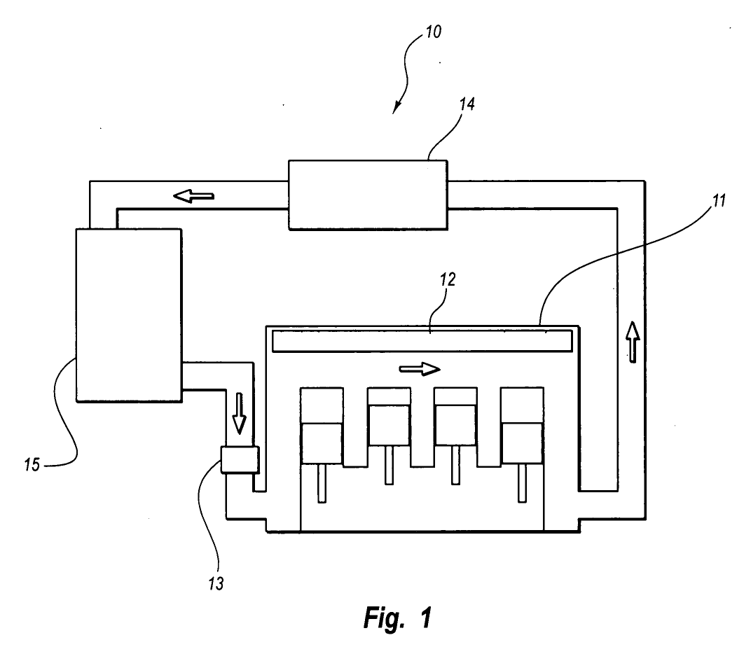

The following explanation of the coolant additive, which is to be used for automobile engines, references the accompanying drawings. FIG. 1 illustrates a typical automobile engine cooling system 10, in which the present invention can be used. The cooling system 10 is used to cool the automobile engine 11 by carrying heat away from the engine 11 and allowing it to dissipate into the air. The coolant absorbs heat from the engine 11 in the water jacket 12 and is circulated through the cooling system 10 by a water pump 13. The coolant passes through a heater 14 that provides heat to the inside of the passenger cabin by extracting heat from the hot coolant as it flows out from the water jacket 12. The hot coolant then circulates through a radiator 15 where the heat is dissipated into the air by way of a fan which blows colder, outside air over the hot coolant, thus cooling the coolant.

In one embodiment of the present invention, the strontium mineral powder contains strontium in a range of about 0.1% to about 0.3% by volume and a crushed mineral (e.g., 0.1 to 1 millimeters in size) containing beta quartz, Anorthite or both. The presence of beta quartz or Anorthite can be determined by X-ray diffraction methods, if necessary, to select the minerals to be used in the coolant additive. In this embodiment of the methods for forming the coolant additive, the strontium mineral powder is heat processed under 800° C. heat. It is then mixed with untreated powder with a mixing ratio (mineral powder to untreated powder), in a range from about 1:1 to about 1:5. This mixture is mixed with acidic water at a mixing ratio in a range from about 10% to about 30% powder by volume, the acidic water having been processed by electrolysis to obtain a pH in a range from about 4 to about 6. Then this mixed solution is placed in a bottle, which is heated to about 40° C. Scattering agents including surfactant ingredients, such as Phosphoric Acid, Armeen Inducer, Polyethylene Oxide Additive, and/or S Colloid are then added to the mixed solution to create the final coolant additive.

One embodiment of the methods for using the coolant additives of the present invention is shown below. For purposes of this example, the coolant capacity is 4000 cc and the engine size is 660 cc. The steps of this method include the following: (1) Start the engine and let the engine idle for between one and five minutes. (2) Stop the engine, open the hood, and unscrew the radiator cap. (3) Remove 150 cc of coolant from the radiator by using, for example, a pump. (4) Add 150 cc of the coolant additive into the radiator. Prior to putting the additive in the radiator, the technician should ensure that the additive is mixed well and that there is no residue remaining on the bottom of the bottle that contained the additive. (5) If necessary, add additional coolant into the radiator to bring the level of coolant to the level recommended by the automobile manufacturer. (6) Put the radiator cap back on the radiator and tighten it. Pour the remaining coolant which was taken out in step (3) above back into the sub tank. (7) Start the engine and let it run until the thermostat is open. At this point, the automobile can be driven and can experience the beneficial results disclosed herein.

III. Experimental Results

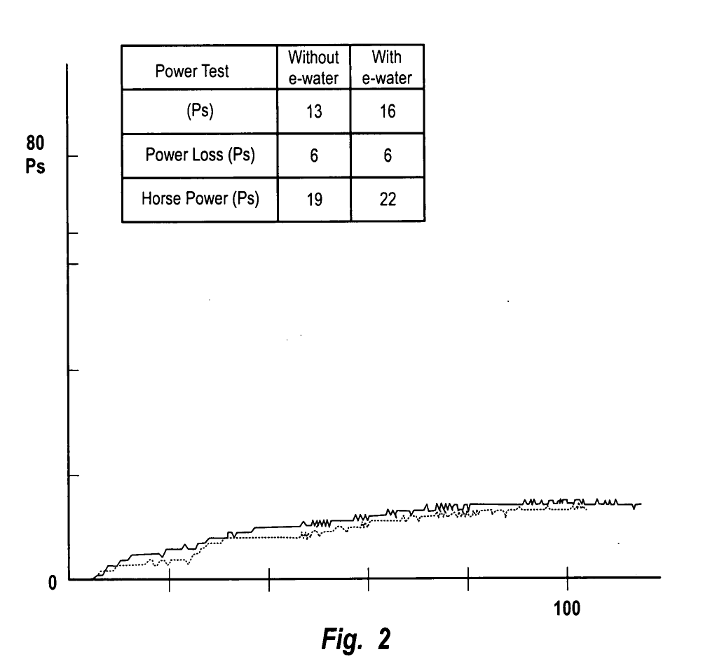

FIG. 2 displays test results on various automobiles using the present invention following the method used above. FIG. 2 shows actual data for 10 automobiles (a through j) which were tested before and after the present invention was used. For each automobile, Carbon Monoxide (unit:%) and Hydro Carbon (unit:ppm) emissions were tested, as well as gas mileage (unit:km/liter). For example, the data shown in (a) correspond to a 1995 Suzuki Wagon R having an odometer reading of 8,595 km. The data indicate that after adding the present invention to the cooling system, the Carbon Monoxide emission decreased from 0.37% to 0.01%, the Hydrocarbon emission decreased from 204 ppm to 21 ppm, and the mileage increased from 10.8 km/liter to 13.8 km/liter. The data on (b) through (j) shows similar results. For the automobiles shown in FIG. 2, when the present invention was used, the average Carbon Monoxide emissions decreased by 86.4%, the average Hydrocarbon emissions decreased by 88.4%, and the average gas mileage increased by 24.9%. These results were obtained under normal driving conditions. However, when driven aggressively, combustion energy is used in acceleration and as a result, mileage may show negative results.

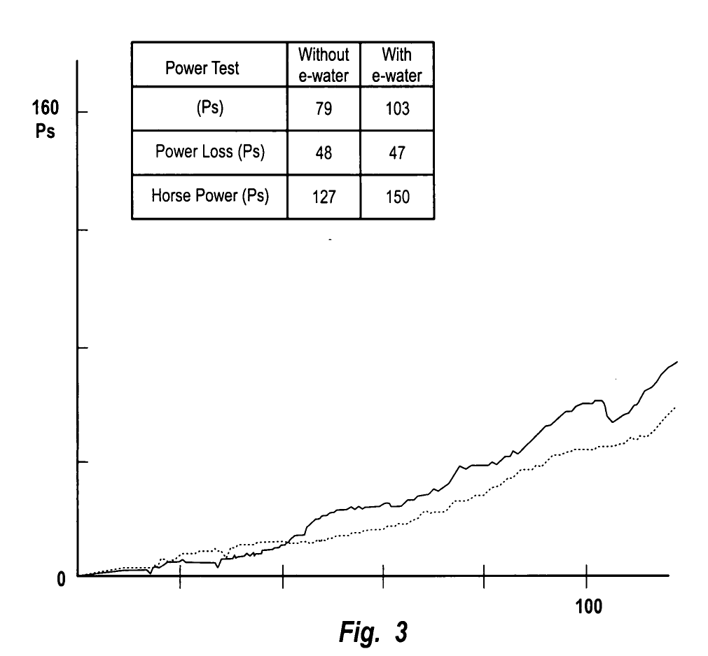

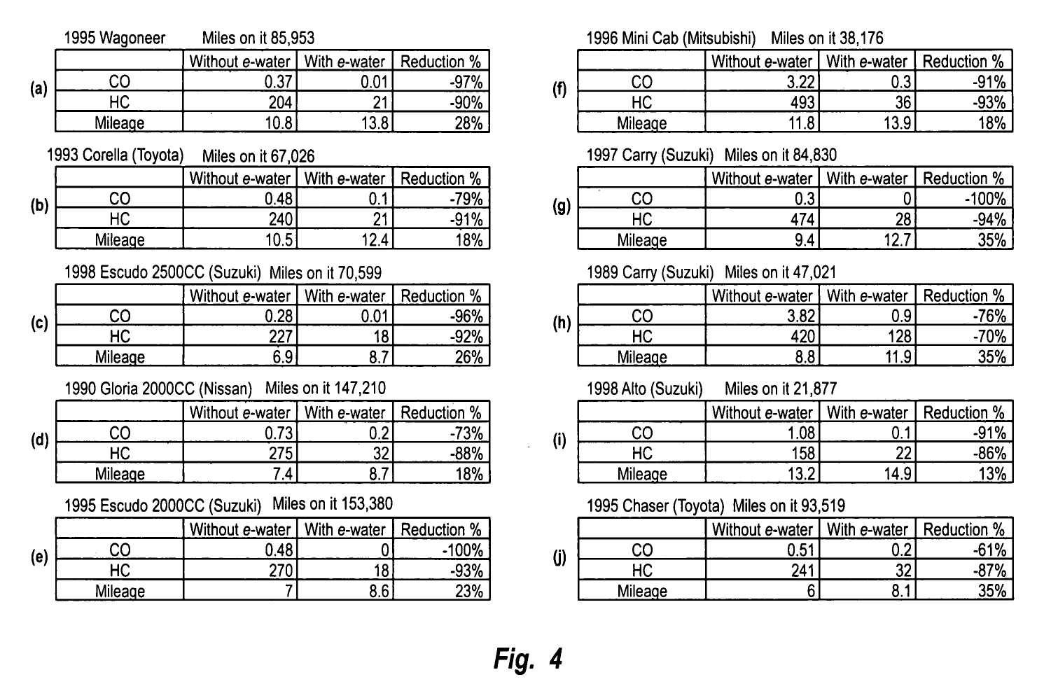

FIGS. 3 and 4 display the relationship of speed (km/h) and power (ps) both before and after coolant additive has been added to the coolant of two separate automobiles. FIG. 3 corresponds to a Daihatsu Mira with an odometer reading of 10,190 kmt while FIG. 4 corresponds to a Toyota Crown with an odometer reading of 85,901 km. As the solid lines in both figures clearly show, adding the coolant additives disclosed herein into the cooling system yielded better results on axis power, power loss, and horsepower.

As explained above, coolant additives of the invention contain strontium mineral powder that has an electrical polarizing effect and a scattering agent that causes the mineral powder float freely in the coolant. When mixed appropriately, the coolant additives result in an increase in engine power, decreased emissions, increased fuel efficiency, reduction in engine noise, reduction in odor inside the passenger cabin, and protection of the coolant based, in certain embodiments of the invention, on the following principles. It is noted, however, that beneficial results are obtained from the use of the coolant additives as disclosed herein, regardless of the nature of the physical processes.

(1) When moisture and heat are given to a conducting agent that has electrical polarization effects in a coolant, substantial amounts of energy are generated. As the temperature gets higher, more energy is released. Because of this energy release, coolant in the radiator becomes positively charged. The temperature is highest around the cylinders such that the greatest energy is also around the cylinders. As a result of the heat, substantial amounts of energy are created inside the coolant.

(2) Because of the high revolutions per minute of the engine and the associated rapid piston movement, a great amount of negative charge is built up in the engine. When this occurs, an exchange of electrons starts to take place between the positive ions within the coolant and the negative ions inside the cylinders. This exchange of electrons gets faster and faster as the temperature rises. As a result, an electromagnetic field is created around the cylinders where the temperature is high.

(3) This electromagnetic field breaks down the molecules of fuel (gasoline or diesel) instantly and makes the fuel more combustible. In addition, the air that is in the combustion chamber carries a negative charge and therefore repels against negative ions and starts moving rapidly.

Because of these aforementioned principles (1) through (3), combustion becomes near-perfect. At the same time, the combusting speed increases allowing a low-temperature, near-perfect combustion of the fuel. Because of the lower temperature combustion Nitrogen Oxide (NOx) is reduced. Also, fuel burns more completely, fuel efficiency increases and emissions are much cleaner. For this reason, the present invention not only increases power, increases fuel efficiency, reduces emissions, and stabilizes water temperature, but it also extends the life of the coolant itself due to its effect of keeping the coolant in a positively charged state. The strontium mineral powder circulates through the engine's cooling system and also passes through the heater core. When it passes through the heater core, a substantial amount of negative ions are released into the passenger cabin. These negative ions neutralize the positively charged odor. While the engine is running, negative ions are continuously released, which take away the odor inside the passenger cabin.

While the invention has been described herein primarily in the context of radiator coolant additives used in combination with automobile engines, the principles of the invention can be readily applied to other systems or environments. For instance, the radiator coolant additives can be used with substantially any cooled internal combustion engine, regardless of the systems or mechanical devices in which the engines or used. More generally, the principles of the invention can also be applied to a variety of other systems that involve or perform combustion of hydrocarbon fuels in which the combustion components are cooled or are used to transfer heat to a medium that can include the coolant additive compositions disclosed herein. Examples of such systems include hydrocarbon fuel engines other than internal combustion engines and power generation furnaces or combustion chambers. The invention can be applied to substantially any combustion processes, such as those described above, including processes used in electrical power plants, chemical manufacturing or processing, petroleum refineries and other petroleum processing, etc. In substantially any of these combustion processes, the materials and processes disclosed herein can be adapted to reduce emissions, improve fuel combustion efficiency, or both, or to otherwise achieve the beneficial results disclosed herein.

As noted herein, the coolant additives result in the generation of negative ions that are released into the passenger cabins of many automobiles in which the coolant additives are used. In general, the principles of the invention can be adapted for use in systems for generating negative ions to be released into the living or working environments of human beings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A radiator coolant additive comprising:
an electrical mineral powder; and
a surfactant that facilitates dispersion of the electrical mineral powder when the radiator coolant additive is mixed with a radiator coolant.

2. The radiator coolant of claim 1, wherein the electrical mineral powder is a strontium mineral powder.

3. The radiator coolant additive of claim 2, further comprising at least one of beta quartz and Anorthite.

4. The radiator coolant additive of claim 3, wherein said at least one of beta quartz and Anorthite is included in the radiator coolant additive in a range of about 10% to about 30% by volume.

5. The radiator coolant additive of claim 2, wherein strontium of the strontium mineral powder is included in the radiator coolant additive in a range from about 0.5% to about 1.0% by volume.

6. The radiator coolant additive of claim 2, further comprising:
ethylene glycol; and
acidic water.

7. The radiator coolant additive of claim 2, wherein the surfactant comprises an ion surfactant.

8. The radiator coolant additive of claim 2, wherein the surfactant comprises a non-ion surfactant.

9. The radiator coolant additive of claim 2, further comprising:
an organic acid; and
carboxylate.

10. The radiator coolant additive of claim 1, wherein the electrical mineral powder is a zirconium mineral powder.

11. A method for operating an automobile engine, comprising:
adding a coolant additive to radiator coolant used in a radiator of the automobile, the coolant additive including:
a strontium mineral powder; and
a surfactant that facilitates dispersion of the electrical mineral powder when the radiator coolant additive is mixed with the radiator coolant; and
causing an engine of the automobile to operate and perform combustion of fuel while being cooled by the radiator coolant having added thereto the coolant additive.

12. The method of claim 11, wherein emissions of the engine are reduced compared to emissions that would have been produced in the absence of the coolant additive.

13. The method of claim 11, wherein fuel efficiency of the automobile is increased compared to fuel efficiency that would have been produced in the absence of the coolant additive.

14. The method of claim 11, wherein engine noise from the engine is reduced compared to engine noise that would have been produced in the absence of the coolant additive.

15. The method of claim 11, wherein horsepower of the engine is increased compared to horsepower that would have been produced in the absence of the coolant additive.

16. The method of claim 11, wherein combustion of the fuel is more complete compared to the combustion that would have been produced in the absence of the coolant additive.

17. The method of claim 11, wherein odors in a passenger cabin of the automobile are reduced compared to odors that would have existed in the absence of the coolant additive.

18. The method of claim 11 wherein, during operation of the engine, the coolant becomes positively charged.

19. The method of claim 18 wherein, during the operation of the engine, fuel within the engine becomes negatively charged.

20. The method of claim 19, wherein, during operation of the engine, an electrical current is established between the coolant to the fuel within the engine and passes through a piston of the engine.

21. A method of manufacturing a coolant additive, comprising:
obtaining a strontium mineral powder that includes at least one of beta quartz and Anorthite;
heating the strontium mineral powder to a temperature of at least 800° C.;
mixing the strontium mineral powder with acidic water.

22. The method of claim 21, further comprising, prior to mixing the strontium mineral powder with the acidic water, mixing the strontium mineral powder with other strontium mineral powder that has not been heated to at least 800° C.

23. The method of claim 21, wherein the strontium mineral powder, after having been mixed with the acidic water, is included in the coolant additive in a range from about 10% to about 30% by volume.
